(19) United States
(12) Patent Application Publication
(10) Pub. No.: US 2006/0219458 A1
(43) Pub. Date: Oct. 5, 2006

(54) Passenger protecting device and method

(75) Inventor: Hirofumi Yamashita, Yokkaichi-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/384,991

(22) Filed: Mar. 20, 2006

(30) Foreign Application Priority Data
Mar. 30, 2005 (JP) 2005-099327

(51) Int. Cl. B60K 28/00; G08G 1/16

(52) U.S. Cl. 180/271; 180/280; 701/301; 180/167

(57) ABSTRACT

A passenger protecting device for a vehicle has a vehicle direction control unit, a collision avoidance judging unit, and at least one of a torque allocation ratio control unit and a helm angle actuator. The torque allocation ratio control unit controls a torque allocation ratio of wheels of the vehicle. The helm angle actuator is connected with the wheels to control helm angles thereof. The vehicle direction control unit controls at least one of the torque allocation ratio control unit and the helm angle actuator, to rotate the vehicle to a predetermined direction in the case where the collision avoidance judging unit determines that the collision of the vehicle is avoidless, so that the injury to the passenger is restricted.

### CROSS REFERENCE TO RELATED APPLICATION

This application is based on a Japanese Patent Application No. 2005-99327 filed on Mar. 30, 2005, the disclosure of which is incorporated herein by reference.

### FIELD OF THE INVENTION

The present invention relates to a passenger protecting device and method for protecting a passenger in a vehicle.

### BACKGROUND OF THE INVENTION

Generally, for example, referring to JP-2002-342899A, a driving aid device is proposed to judge a possibility of a collision with a vehicle and inform, for example, a driver about the possible collision. Based on the information of the potential collision, the driver of the vehicle can early perform operations of a brake, a handle and the like to avoid the collision. Thus, an actual collision of the vehicle can be restricted.

However, for example, in the case where the collision avoidance operations of the driver are late, the collision of the vehicle may become avoidless. In this case, it is preferable that a hurt to a passenger in the vehicle can be mitigated as possible.

### SUMMARY OF THE INVENTION

In view of the above-described disadvantage, it is an object of the present invention to provide a passenger protecting device and method for mitigating a damage of a passenger of a vehicle in a collision of the vehicle.

According to a first aspect of the present invention, a passenger protecting device for a vehicle is provided with a torque allocation ratio control unit for controlling a torque allocation ratio between at least one left wheel and at least one right wheel of the vehicle, a collision avoidance judging unit for judging whether or not a collision of the vehicle is avoidable, and a vehicle direction control unit. In the case where the collision avoidance judging unit determines that the collision of the vehicle is avoidless, the vehicle direction control unit controls the torque allocation ratio control unit to rotate the vehicle to a predetermined direction so that an injury to the passenger is restricted.

When the torque allocation ratio is controlled by the torque allocation ratio control unit to become uneven between the right wheel and the left wheel of the vehicle, a difference between rotation speeds of the wheels occurs so that the direction of the vehicle varies. Therefore, in the case where the collision avoidance judging unit determines that the collision of the vehicle is avoidless, the torque allocation ratio control unit can be controlled to rotate the vehicle to the predetermined direction where the hurt to the passenger can be reduced.

Preferably, the passenger protecting device further has a helm angle actuator which is connected with at least one left wheel and at least one right wheel of the vehicle to control helm angles of the wheels. In the case where the collision avoidance judging unit determines that the collision of the vehicle is avoidless, the vehicle direction control unit controls both the torque allocation ratio control unit and the helm angle actuator to rotate the vehicle to the predetermined direction, so that the injury to the passenger is restricted.

Because the vehicle can be rotated via the torque allocation ratio control unit and the helm angle actuator, it takes shorter time to rotate the vehicle to the predetermined direction at which the hurt to the passenger can be restricted. Therefore, the vehicle can be rotated to the predetermined direction even when the period between the time when it is determined that the collision is avoidless and the time when the collision practically occurs is short.

According to a second aspect of the present invention, a passenger protecting device for a vehicle is provided with a helm angle actuator which is connected with at least one left wheel and at least one right wheel of the vehicle to control helm angles of the wheels, a collision avoidance judging unit for judging whether or not a collision of the vehicle is avoidable, and a vehicle direction control unit. In the case where the collision avoidance judging unit determines that the collision of the vehicle is avoidless, the vehicle direction control unit controls the helm angle actuator to rotate the vehicle to a predetermined direction so that an injury to the passenger is restricted.

In this case, the vehicle direction control unit controls the helm angle actuator to rotate the vehicle to the predetermined direction so that the injury to the passenger can be reduced, when the collision avoidance judging unit determines that the collision of the vehicle is avoidless.

According to a third aspect of the present invention, a passenger protecting method for a vehicle includes calculating a distance between the vehicle and an obstacle, detecting a velocity of the vehicle, determining whether or not a collision between the vehicle and the obstacle is avoidable based on the velocity of the velocity and the distance between the vehicle and the obstacle, determining whether or not there are passengers on seats of the vehicle, and rotating the vehicle to a predetermined direction in the case where it is determined that the collision is avoidless. The predetermined direction of the vehicle is set so that the seat where it is determined that there is no passenger is positioned at a collision side as compared with the seat where it is determined that there is a passenger.

Thus, in the case where it is determined that the collision is avoidless, the seat where the non-passenger judgment is decided becomes at the collision side as compared with the seat where it is determined that there is a passenger. Therefore, the passenger can become far from the collision portion of the vehicle, so that the injury to the passenger can be restricted.

### BRIEF DESCRIPTION OF THE DRAWINGS

Other objects, features and advantages of the present invention will become more apparent from the following detailed description made with reference to the accompanying drawings, in which:

FIG. 1 is a schematic view showing a main construction of a passenger protecting device according to a first embodiment of the present invention; and

FIG. 2 is a flow chart showing a main control process executed by a first ECU according to the first embodiment.

### DETAILED DESCRIPTION OF THE EXAMPLE EMBODIMENTS

(First Embodiment)

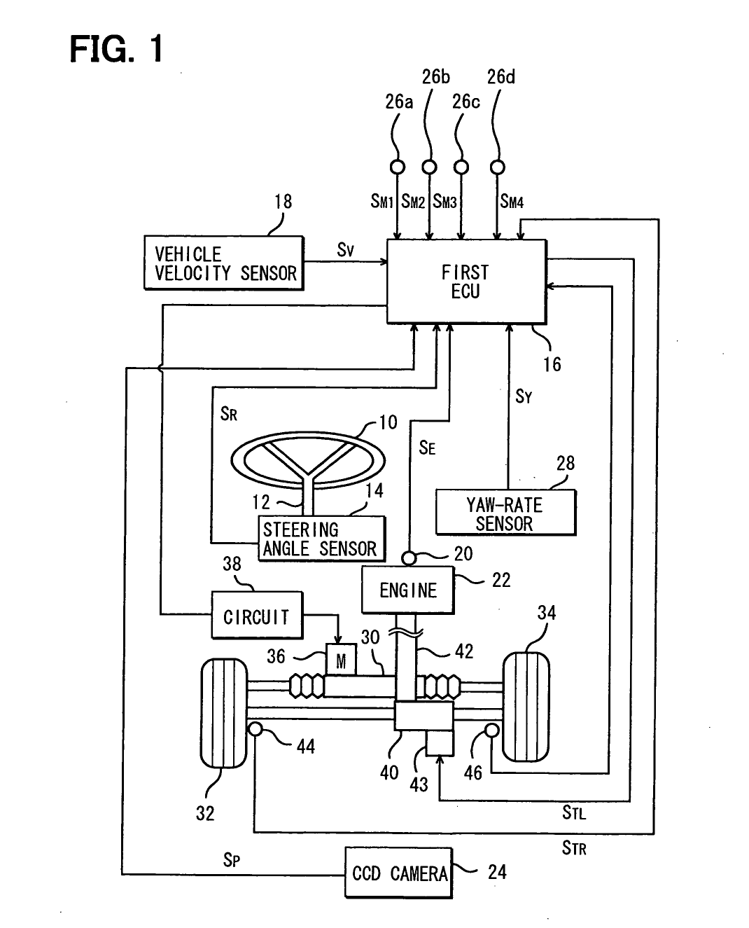

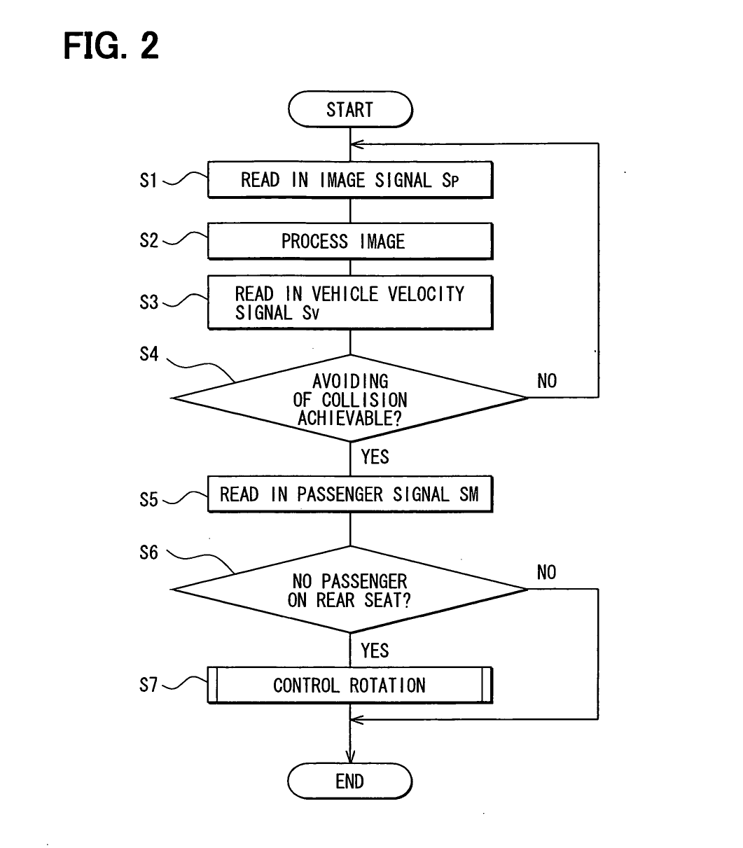

A passenger protecting device according to a first embodiment of the present invention will be described with reference to FIGS. 1 and 2. The passenger protecting device can be suitably used for a vehicle, for example. As shown in FIG. 1, a steering shaft 12 is fixed at a center portion of a steering wheel 10 of the vehicle. That is, the steering wheel 10 is attached to one axial end of the steering shaft 12. A steering angle sensor 14 is mounted at other axial end of the steering shaft 12, to detect a helm angle R (steering angle) of the steering wheel 10 and send steering signals Sr (responding to steering angle R) to a first ECU 16.

A velocity V of the vehicle is detected by a velocity detection unit 18 (e.g., velocity sensor), which sends vehicle velocity signals Sv corresponding to the vehicle velocity V to the first ECU 16. A rotation speed E of an engine 22 of the vehicle is detected by an engine rotation speed sensor 20, which sends rotation speed signals SE corresponding to the rotation speed E to the first ECU 16.

A CCD camera 24 (distance detection unit) is mounted at a front portion of the vehicle, for a sequential pickup of images in a predetermined range at the front side of the vehicle, and sends image signals Sp corresponding to the pickup images to the first ECU 16. Thus, a distance between the vehicle and an obstacle at the vehicle front side can be detected.

A passenger detection unit is provided to detect whether or not there is a passenger sitting on each of seats (e.g., four seats which are arrayed at two rows) of the vehicle. The passenger detection unit can include multiple (e.g., four) sitting sensors, each of which can be constructed of multiple switches, which are mounted on the sitting surface of the seat to become ON/OFF responding to a sitting load exerted on the sitting surface.

The first sitting sensor 26a, the second sitting sensor 26b, the third sitting sensor 26c and the fourth sitting sensor 26d (which constitute passenger detection unit) respectively detect sittings (passengers) on the driver seat, the assistant seat, the first rear seat (at rear side of driver seat) and the second rear seat (at rear side of assistant seat), for example. The sitting sensors 26a-26d respectively send signals SM1, SM2, SM3 and SM4, each of which indicates whether or not there is a passenger on the corresponding seat, to the first ECU 16.

A yaw-rate Sensor 28 is provided to detect a yaw rate Y of the vehicle and send yaw rate signals SY corresponding to the yaw rate Y to the first ECU 16. A helm angle actuator 30 is connected with a right front wheel 32 and a left front wheel 34 which are driving wheels of the vehicle, and driven by an electrical motor 36 or the like to change helm angles of the front wheels 32 and 34. A driving control circuit 38 performs a driving control of the electrical motor 36 based on a helm angle command signal from the first ECU 16.

A torque allocation ratio control unit 40 is mechanically connected with a propeller shaft 42, to transmit a driving force from the engine 22 to the front wheels 32 and 34 through the propeller shaft 42. The torque allocation ratio control unit 40 controls a driving torque allocation ratio (torque allocation ratio) by adjusting an allocation ratio between the driving forces (from engine 22) which are respectively applied to the right front wheel 32 and the left front wheel 34.

A second ECU 43 controls the torque allocation ratio control unit 40 based on signals from the first ECU 16. An actual torque TR applied to the right front wheel 32 is detected by a first torque sensor 44, and an actual torque TL applied to the left front 34 is detected by a second torque sensor 46. Torque signals S_{TR} and S_{TL} corresponding to the actual torques TR and TL are sent to the first ECU 16 by the torque sensors 44 and 46.

The first ECU 16 is, for example, a micro computer having a CPU, a ROM, a RAM and the like, to perform a predetermined calculation operation based on the signals input thereto according to a program beforehand memorized in the RAM. For example, the first ECU 16 can determine the helm angles of the front wheels 32 and 34 based on the steering signals SR supplied by the steering angle sensor 14, and output the helm angle command signal to the driving control circuit 38 so that the front wheels 32 and 34 are respectively provided with predetermined helm angles.

The first ECU 16 performs an operation (referring to FIG. 2) to restrict (prevent) a hurt to the passenger in a collision of the vehicle, based on the supplied signals. The operation shown in FIG. 2 is repeated during the traveling of the vehicle.

Referring to FIG. 2, at first, at step S1, the image signal S_{P} from the CCD camera 24 is input to the first ECU 16. Then, at step S2, the image signal S_{P} is image-processed to calculate the distance (front side distance) between the vehicle and the obstacle (such as other vehicle, building or the like) at the vehicle front side. Thereafter, at step S3, the vehicle velocity signal S_{V} is input to the first ECU 16.

At step S4 (corresponding to collision avoidance judging unit), it is judged whether or not the collision of the vehicle can be avoided (by using well-known discrimination algorithm) based on the distance (calculated at step S2) between the vehicle and the obstacle of the vehicle front side and the vehicle velocity V, which is decided according to the vehicle speed signal SV input to the first ECU 16 at step S3.

The judgment at step S4 can be performed by comparing the front side distance calculated at step S2 and a cease estimation distance, which is decided according to a map between the vehicle speed and the cease estimation distance. The cease estimation distance indicates how long the vehicle proceeds from the braking start to the braking cease in the case where the brake is depressed by a maximum pedal force, for example.

In the case where it is determined at step S4 that the collision of the vehicle is avoidless (that is, judgment result at step 4 is “NO”), the process shown in FIG. 2 will be repeated from step S2. On the other hand, in the case where it is determined at step S4 that the collision of the vehicle can be avoided (that is, judgment result at step 4 is “YES”), step S5 will be performed. At step S5, the passenger signals SM1˜SM4 are input to the first ECU 16 from the sitting sensors 26a˜26d.

Thereafter, at step S6, it is judged whether or not there is no passenger on the rear seats based on the passenger signals SM1˜SM4, which are read in at step S5. In the case where it is determined at Step S6 that there is a passenger on the rear seats (that is, judgment result at step 6 is “NO”), the operation shown in FIG. 2 will be ended.

On the other hand, in the case where it is determined at step s6 that there is no passenger on the rear seats (that is, judgment result at step 6 is “YES”), step S7 will be performed. At step S7 (correspond to vehicle direction control unit), a control command signal is sent to the second ECU 43 to control the torque allocation ratio control unit 40, while the helm angle command signal is sent to the driving control circuit 38 to control the helm angle actuator 30 so that the vehicle is rotated to have a predetermined direction.

The predetermined direction of the vehicle is beforehand set to reduce a hurt to the passenger in the collision. For example, the vehicle can be rotated to have the predetermined direction so that the rear seat portion (rear portion) of the vehicle becomes the collision side, that is, the traveling-direction front side.

Specifically, the first ECU 16 controls the torque allocation ratio control unit 40, in such a manner that the torque allocation ratio between the front wheels 32 and 34 becomes substantially equal to a predetermined value while practical torques TL and TR of the front wheels 32 and 34 are decided based on the torque signals S_{TR} and S_{TL} from the first torque sensor 44 and the second torque sensor 46. Moreover, the first ECU 16 sends the helm angle command signal to the driving control circuit 38 to control the helm angle actuator 30 so as to rotate the vehicle, while the rotation angle of the vehicle is consecutively calculated based on the vehicle rotation speed (i.e., yaw-rate signal S_{Y} from yaw-rate sensor 28). Thus, the vehicle is rotated by, for example, substantial 180° with respect to the position thereof before step S7 is performed. After a predetermined period has elapsed from step S7, the operation of the first ECU 16 with reference to FIG. 2 will be repeated from step S1.

In this case, the direction of the vehicle is changed so that the rear seat portion (rear portion) of the vehicle becomes the collision side. That is, the predetermined direction of the vehicle is set so that the rear seats where a non-passenger judgment is decided are positioned at the collision side as compared with the front seats where it is determined that there is a passenger.

Because the vehicle is rotated so that the rear portion of the vehicle becomes the vehicle front side (in traveling direction) which is the collision side, the front seat portion of the vehicle becomes far from the collision side. Thus, the shock due to the collision which can be transmitted to the passenger on the front seat can be restricted, so that a harm to the passenger in the vehicle collision can be reduced. Moreover, in this case, because the vehicle collision occurs in the case where the passenger of the front seat faces the rear side of the vehicle traveling direction, the passenger of the front seat will be pressed against the backing portion of the seat due to the impact from the collision. Therefore, the passenger can be restricted from being thrown from the seat. Thus, a hurt to the passenger in the vehicle collision can be reduced.

According to this embodiment, in the case where it is determined at step S4 (collision avoidance judging unit) that the collision of the vehicle is avoidless, the helm angle actuator 30 and/or the torque allocation ratio control unit 40 can be controlled at step S7 (vehicle direction control unit) so that the vehicle is rotated until the rear seat portion of the vehicle becomes the front side of the vehicle traveling direction to face the obstacle. Accordingly, the injury to the passenger of the front seat can be restricted.

(Second Embodiment)

In the above-described first embodiment, at step S7 (vehicle direction control unit), in the case where it is determined that there is no passenger on the rear seats, the vehicle predetermined direction for restricting the hurt to the passenger is beforehand set in such a manner that the vehicle rear seat portion becomes the vehicle collision side. In this case, the vehicle is rotated to have the predetermined direction.

According to a second embodiment of the present invention, the predetermined direction of the vehicle can be set so that the seats where it is determined that there is no passenger are positioned at a collision side as compared with the seat where it is determined that there is a passenger.

For example, in the case where it is determined that there is no passenger on the assistant seat and the second rear seat which is positioned at the rear side of the assistant seat, the predetermined direction of the vehicle at which the injury to the passenger is to be restricted is beforehand set in such a manner that the side of the assistant seat and the second rear seat becomes the collision side. That is, in this case, the vehicle direction making the side of the assistant seat and the second rear seat of the vehicle face the obstacle is set as an injury reduction direction for the vehicle.

In this case, the vehicle can be oriented so that, for example, the assistant seat and the second rear seat of the vehicle are positioned at the collision side.

(Other Embodiments)

Although the present invention has been fully described in connection with the preferred embodiments thereof with reference to the accompanying drawings, it is to be noted that various changes and modifications will become apparent to those skilled in the art.

In the above-described embodiments, the front wheels 32 and 34 of the vehicle are the driving wheels. However, the present invention can be also suitably used for a rear-wheel driving vehicle (where rear wheels are driving wheels) or a four-wheel driving vehicle (where four wheels are driving wheels). In the case of the front-wheel driving vehicle or the rear-wheel driving vehicle, the helm angle actuator 30 and/or the torque allocation ratio control unit 40 can control the driving wheels, or alternatively control a pair of the right and left wheels which are not the driving wheels. More alternatively, the helm angle actuator 30 and/or the torque allocation ratio control unit 40 can be also set to control all the wheels of the vehicle regardless of the two-wheel driving vehicle or the four-wheel driving vehicle.

Moreover, in the vehicle described in the first and second embodiments, the steering wheel 10 is not mechanically connected with the front wheels 32 and 34 (which are steering wheels). However, the present invention can be also suitably used for the vehicle where the steering wheel 10 is mechanically connected with the steering wheels (e.g., front wheels 32 and 34).

Furthermore, the driving source of the vehicle in the present invention is not limited to the engine 22. For example, the present invention can be also suitably used for an electrical vehicle having an electrical motor as a driving source, a hybrid vehicle having the engine and the electrical motor as the driving source, and the like.

In the first and second embodiments, the torque allocation ratio control unit 40 controls the torque allocation ratio between the wheels 32 and 34 by changing the allocation ratio of the driving forces (from engine 22, for example) applied to the wheels 32 and 34. However, the torque allocation ratio control unit 40 can also control the torque allocation ratio between the wheels 32 and 34 by separately controlling the braking forces applied to the wheels 32 and 34, or/and by changing the above-described allocation ratio of the driving forces applied to the wheels 32 and 34.

Moreover, in the first and second embodiment, the CCD camera 24 is provided as the distance detection unit. The distance between the vehicle and the obstacle at the vehicle front side is calculated based on the images picked-up by the CCD camera 24. However, the distance between the vehicle and the obstacle can be also calculated via other means. For example, a radar can be provided to output radio wave in a predetermined direction (e.g., vehicle traveling direction) and receive reflection wave. In this case, the distance between the vehicle and the obstacle of the vehicle front side can be calculated based on signals from the radar. More alternatively, in a vehicle having a navigation system, the distance between the vehicle and the obstacle can be also calculated based on information from the navigation system.

In the first and second embodiments, the vehicle orientation is determined based on the yaw-rate Y. However, an electric compass which uses a gyrocompass or magnetism of the earth can be also used to determine the orientation of the vehicle.

Such changes and modifications are to be understood as being in the scope of the present invention as defined by the appended claims.

What is claimed is:

1. A passenger protecting device for a vehicle, the passenger protecting device comprising:
a torque allocation ratio control unit for controlling a torque allocation ratio between at least one right wheel and at least one left wheel of the vehicle;
a collision avoidance judging unit for judging whether or not a collision of the vehicle is avoidable; and
a vehicle direction control unit, wherein
in the case where the collision avoidance judging unit determines that the collision of the vehicle is avoidless, the vehicle direction control unit controls the torque allocation ratio control unit to rotate the vehicle to a predetermined direction so that an injury to the passenger is restricted.

2. A passenger protecting device for a vehicle, the passenger protecting device comprising:
a helm angle actuator which is connected with at least one right wheel and at least one left wheel of the vehicle to control helm angles of the wheels;
a collision avoidance judging unit for judging whether or not a collision of the vehicle is avoidable; and
a vehicle direction control unit, wherein
in the case where the collision avoidance judging unit determines that the collision of the vehicle is avoidless, the vehicle direction control unit controls the helm angle actuator to rotate the vehicle to a predetermined direction so that an injury to the passenger is restricted.

3. The passenger protecting device according to claim 1, further comprising
a helm angle actuator which is connected with the at least one right wheel and the at least one left wheel of the vehicle to control helm angles of the wheels, wherein
in the case where the collision avoidance judging unit determines that the collision of the vehicle is avoidless, the vehicle direction control unit controls both the torque allocation ratio control unit and the helm angle actuator to rotate the vehicle to the predetermined direction, so that the injury to the passenger is restricted.

4. The passenger protecting device according to claim 1, further comprising
a passenger detection unit for detecting whether or not there is a passenger on each of seats of the vehicle, wherein
the predetermined direction of the vehicle is set, so that the seat where it is determined that there is no passenger is positioned at a collision side as compared with the seat where it is determined that there is a passenger.

5. The passenger protecting device according to claim 2, further comprising
a passenger detection unit for detecting whether or not there is a passenger on each of seats of the vehicle, wherein
the predetermined direction of the vehicle is set, so that the seat where it is determined that there is no passenger is positioned at a collision side as compared with the seat where it is determined that there is a passenger.

6. The passenger protecting device according to claim 1, wherein
the torque allocation ratio control unit controls the torque allocation ratio of the wheels, by changing at least one of a driving force and a braking force which are applied to the wheel.

7. The passenger protecting device according to claim 1, further comprising:
a velocity detection unit for detecting a velocity of the vehicle; and
a distance detection unit for detecting a distance between the vehicle and an obstacle, wherein
the collision avoidance judging unit judges whether or not the collision of the vehicle is avoidable based on the velocity detected by the velocity detection unit and the distance detected by the distance detection unit.

8. The passenger protecting device according to claim 2, further comprising:
a velocity detection unit for detecting a velocity of the vehicle; and
a distance detection unit for detecting a distance between the vehicle and an obstacle, wherein
the collision avoidance judging unit judges whether or not the collision of the vehicle is avoidable based on the velocity detected by the velocity detection unit and the distance detected by the distance detection unit.

9. The passenger protecting device according to claim 7, wherein:
the velocity detection unit is a velocity sensor; and
the distance detection unit is one of a CCD camera, a radar and a navigation system.

10. The passenger protecting device according to claim 8, wherein:
the velocity detection unit is a velocity sensor; and
the distance detection unit is one of a CCD camera, a radar and a navigation system.

11. The passenger protecting device according to claim 4, wherein the passenger detection unit is constructed of a plurality of sitting sensors, which are respectively mounted on sitting surfaces of the seats of the vehicle.

12. The passenger protecting device according to claim 5, wherein the passenger detection unit is constructed of a plurality of sitting sensors, which are respectively mounted on sitting surfaces of the seats of the vehicle.

13. A passenger protecting method for a vehicle, comprising:
calculating a distance between the vehicle and an obstacle;
detecting a velocity of the vehicle;
determining whether or not a collision between the vehicle and the obstacle is avoidable based on the velocity of the vehicle and the distance between the vehicle and the obstacle;
determining whether or not there are passengers on seats of the vehicle; and
rotating the vehicle to a predetermined direction in the case where it is determined that the collision is avoidless, wherein
the predetermined direction of the vehicle is set so that the seat where it is determined that there is no passenger is positioned at a collision side as compared with the seat where it is determined that there is a passenger.

14. The passenger protecting method according to claim 13, wherein the vehicle is rotated by substantial 180° with respect to a position thereof before the rotating process is performed.
